(19) United States
(12) Patent Application Publication
(10) Pub. No.: US 2021/0366261 A1
(43) Pub. Date: Nov. 25, 2021

(54) SYSTEM AND METHODS FOR MANAGED MOISTURE MONITORING/DETECTION AND NOTIFICATION

(71) Applicant: SEMPER PERVIGILIS CORP., Sacramento, CA (US)

(72) Inventors: John C. Flanigan, Sacramento, CA (US); Timothy H. Flanigan, Sacramento, CA (US)

(21) Appl. No.: 17/252,692

(22) PCT Filed: Jun. 14, 2019
(86) PCT No.: PCT/US2019/037363

§ 371 Date: Dec. 15, 2020

Related U.S. Application Data
(60) Provisional application No. 62/685,890, filed on Jun. 15, 2018.

(51) Int. Cl. G08B 21/20; G01N 27/04

(52) U.S. Cl. CPC G08B 21/20; G01N 27/041; G01N 27/048

(57) ABSTRACT

This disclosure generally relates to a system comprising sensors for detecting moisture in dry wall A managed moisture monitoring system is presented which comprises a central control system and a plurality of moisture monitoring devices configured to automatically perform a plurality of moisture measurements to collect moisture measurement data, wherein the central control system is in communication with the plurality of moisture monitoring devices. If moisture measurement data is detected above a threshold, the central control system may send an alert to a user. The system may advantageously provide continuous monitoring capabilities and adjustable/adaptive detection and notification features.

### TECHNICAL FIELD

This disclosure generally relates to systems and methods for detecting moisture in drywall, and specifically to an automated moisture monitoring and management system and method thereof comprising moisture sensors with continuous monitoring capabilities and adjustable/adaptive detection and notification features.

### BACKGROUND

According to the 2004 book by the Institute of Medicine of The National Academy of Science entitled Damp Indoor Spaces and Health, “There are over 119 million housing units in the United States and nearly 4.7 million commercial buildings (U.S. Census Bureau, 2003) and almost all of them experience leaks, flooding, or other forms of excessive indoor dampness at some time.” More recently, the 2012 Commercial Buildings Energy Consumption Survey (CBECS) conducted by the U.S. Energy Information Administration estimated that, “there were 5.6 million commercial buildings in the United States in 2012, comprising 87 billion square feet of floorspace, representing a 14% increase in the number of building and a 21% increase in floorspace since 2003,” meaning that the number of areas at risk for excess moisture and dampness will only continue to increasing.

The issue of mold contamination in residential and commercial buildings is quickly surpassing lead-based paint and asbestos as one of the real estate industry's most vexing and, potentially, costly problems.

Virtually every mold expert is in agreement that the best way to prevent mold growth in homes and buildings, generally, and on drywall, specifically, is to prevent the intrusion of moisture on and in the walls, themselves. Mold will begin to grow on drywall if moisture is not detected and remediated within the first 48 hours. The Federal Environmental Protections Agency's website contains a section dedicated to information concerning mold which states that “the best way to control mold growth is to control moisture.” And according to the National Multi-Housing Council, “there is no practical way to eliminate all molds and mold spores in the indoor environment. The way to control indoor mold growth is to control moisture.”

Insurance companies throughout the country have been terminating their policy coverage relative to mold claims. At first, this caused a slight decrease in mold suits. However, it was merely a lull in the storm. Trial lawyers who are experienced mold litigators are independently confirming that mold litigation in on the rise again and will continue to be indefinitely. This is further supported by the fact that new literature is coming out every day on the issue, such as the previously cited book by the Institute of Medicine of The National Academy of Science, which further supports the position that serious health problems are associated with mold contamination. Consider the following quotes from the introduction to Damp Indoor Spaces and Health:

‘Almost all homes, apartments, and commercial buildings will experience leaks, flooding, or other forms of excessive indoor dampness at some point. Not only is excessive dampness a health problem by itself, it also contributes to several other potentially problematic types of situations. Molds and other microbial agents favor damp indoor environments, and excess moisture may initiate the release of chemical emissions from damaged building materials and furnishings.

### SUMMARY

According to the present disclosure, a moisture monitoring system may comprise a central control system comprising a user interface subsystem and programmable settings; and a plurality of moisture monitoring devices, each moisture monitoring device comprising first and second sensors, and an operating control system comprising operating conditions; wherein the plurality of moisture monitoring devices may be configured to automatically perform a plurality of moisture measurements to collect moisture measurement data from drywall material using the first and second sensors; wherein a first remote subsystem may comprise a first portion of the plurality of moisture monitoring devices, and a second remote subsystem may comprise a second portion of the plurality of moisture monitoring devices, the first and second remote subsystems being in communication with the central control system and located in different physical locations; wherein the central control system may be configured to receive and store moisture measurement data from the first and second remote subsystems, and to send instructions to the first and second remote subsystems to modify the operating conditions of the operating control systems of the first and second portions of the plurality of moisture monitoring devices; wherein the central control system may be configured such that at least the programmable settings are accessible by a user through the user interface subsystem; and wherein, when the central control system receives moisture measurement data that is above an alert threshold, the central control system may send an alert to a user through the user interface subsystem.

In an embodiment, the different physical locations may comprise one of: different walls within a room, different walls within a structure, different rooms within a structure, different floors of a structure, different structures, or different street addresses.

In an embodiment, the operating conditions may comprise a frequency of measurement.

In an embodiment, the operating conditions may comprise a duration of measurement.

In an embodiment, the central control system may be a web-based application comprising a data server which is accessible by a user through the user interface subsystem.

In an embodiment, the programmable settings may be configured to be modifiable by a user through the user interface subsystem.

In an embodiment, the central control system may comprise a user hierarchy and is configured to send the alert to users from the user hierarchy based on which remote subsystem the above-first threshold moisture measurement data was sent from.

In an embodiment, the user interface subsystem may comprise a web interface accessed through an internet browser or a mobile application (“app”).

In an embodiment, the alert may comprise a notification selected from a group consisting of a text message, a mobile app notification, an email notification, an audible alarm, a visual alarm, and an automated phone call.

In an embodiment, wherein a first moisture monitoring device of the plurality of moisture monitoring devices may be configured such that when the first moisture monitoring device collects moisture measurement data above the alert threshold, the first moisture monitoring device may emit either of an audible alarm, a visual alarm, or both.

In an embodiment, when moisture measurement data sent to the central control system from a first moisture monitoring device of the plurality of moisture monitoring devices is above a screening threshold, the central control system may instruct the operating control system of the first moisture monitoring device to increase a frequency of measurement of the operating conditions of the first moisture monitoring device.

In an embodiment, if the moisture measurement data of the first moisture monitoring device continues to be above the screening threshold after a set number of measurement cycles after the frequency of measurement of the first moisture monitoring device has been increased, the central control system may send the alert through the user interface subsystem.

In an embodiment, wherein the first and second sensors of the plurality of moisture monitoring devices may comprise conductive probes, and moisture measurement data may comprise a voltage difference measured across the first and second conductive probes of a first moisture monitoring device of the plurality of moisture monitoring devices.

In an embodiment, the alert threshold may be dynamic.

In an embodiment, the moisture monitoring system may further comprise an intermediate subsystem wherein the intermediate subsystem may be operable to communicate with the central control system and with one of the first or second remote sub systems.

In an embodiment, a method of moisture monitoring is disclosed.

In an embodiment, a method of installing a moisture monitoring system is disclosed.

### BRIEF DESCRIPTION OF THE DRAWINGS

Embodiments are illustrated by way of example in the accompanying FIGURES, in which like reference numbers indicate similar parts, and in which:

FIG. 1A is a perspective view illustration of an embodiment of a moisture monitoring device;

FIG. 1B is a side perspective view illustration of an embodiment of a moisture monitoring device with conductive probes arranged through drywall material;

FIG. 2A is a block diagram illustration of an embodiment of a moisture monitoring system;

FIG. 2B is a block diagram illustration of an embodiment of a moisture monitoring system comprising first and second remote subsystems;

FIG. 2C is a block diagram illustration of an embodiment of a moisture monitoring system with remote conductive probes;

FIG. 3 is a flow chart illustration of an embodiment of a moisture monitoring system;

FIG. 4 illustrates an embodiment of a moisture monitoring system comprising a first remote subsystem;

FIG. 5 illustrates an embodiment of a moisture monitoring system comprising first, second, and third remote subsystems;

FIG. 6A-FIG. 6C illustrate exemplary embodiments of locations where a moisture monitoring device may be located;

FIG. 7A-FIG. 7E illustrate embodiments of a user interface subsystem of a moisture monitoring system;

FIG. 8 is a block diagram illustration of an embodiment of a moisture monitoring system comprising an intermediate subsystem.

### DETAILED DESCRIPTION

The most common and abundant wall construction material used in the United States and Canada since World War II is drywall. The chemical composition of drywall is hydrated calcium sulphate, commonly referred to as Gypsum, a compound which is highly resistive to an electric current when dry, yet can become electrically conductive when moist. Virtually all piping materials used for conveying pressurized water has been shown to leak under varying scenarios, making it important to detect these increasing moisture levels early so that corrective intervention can occur before there is significant material damage or mold development. Additionally, as properties age, the risk and associated cost of water damage will also increase, becoming an expensive liability.

In the present application, we disclose a system to detect moisture within drywall material. The approach combines a unique application of simple electronics and drywall chemistry for the purpose of immediately detecting moisture on and in drywall in order to prevent the growth of mold. The system described herein is capable of providing continuous monitoring of moisture 24 hours a day, 7 days a week, and 365 days a year.

The system described herein may incorporate a plurality of moisture monitoring devices, such as the moisture detection apparatus described in U.S. Pat. No. 6,798,220 (220 patent), which is herein incorporated by reference in its entirety. Described therein is an electrical instrument designed specifically to monitor and detect moisture (primarily water) on the surfaces of walls inside the wall cavities of buildings, as well as within the walls themselves, for the purpose of alerting the residents or occupants therein of a potential for the growth of molds. Therein, said inside wall surfaces and wall interiors are, for the most part, impossible to observe absent an intrusion into or removal of a portion of the walls. As used herein, the term “drywall” refers to the material used in the construction of buildings, commonly known as drywall, wallboard, Sheetrock, or gypsum board (gypboard), with hydrous calcium sulphate as a main ingredient. Furthermore, the principles and embodiments disclosed herein may be adapted for use in other materials such as wood, concrete, or other building materials.

As describe in the '220 patent, a feature of the moisture monitoring device is its unique ability to detect moisture and dripping or flowing water on and in vertical walls. Another feature of the electrical instrument is in its use of a resistance-based electrical application, which also utilizes the unique chemical composition of drywall and the change in its conductivity based on the concentration of moisture therein, to monitor moisture inside the walls of buildings and on their hidden surfaces for the specific purpose of preventing the growth of molds thereon once moisture has been detected.

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

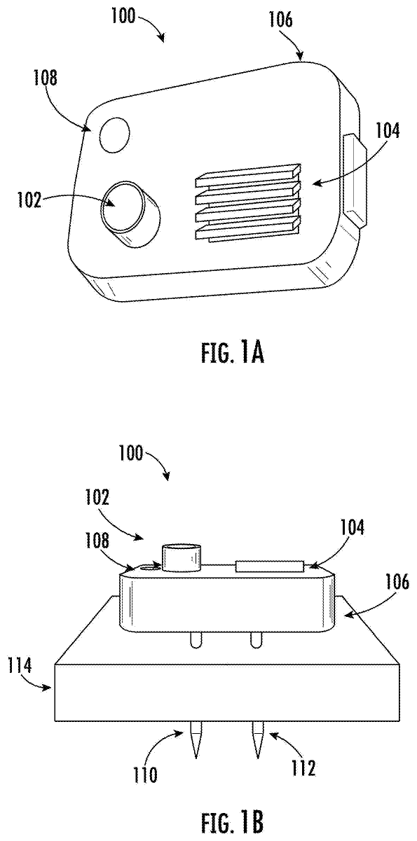

FIG. 1A is a perspective view illustration of an embodiment of a moisture monitoring device 100. In an embodiment, moisture monitoring device 100 may comprise an outer enclosure 106. Moisture monitoring device 100 may be equipped with an audible alarm 104, and a visual alarm 102. In the event moisture is detected by moisture monitoring device 100, audible alarm 104 and visual alarm 102 may be activated in order to notify an appropriate user. Moisture monitoring device 100 may also be equipped with a communication facility 108 which is configured to communicate with a central control system (not shown). Communication facility 108 may be a Wi-Fi capable device, which interfaces with a local Wi-Fi internet router to communicate with the central control system. Furthermore, moisture monitoring device 100 may possess a wired internet connection (not shown) in order to communicate with the central control system.

FIG. 1B is a side perspective view illustration of moisture monitoring device 100. Moisture monitoring device 100 may further comprise sensors 110 and 112, which in the embodiment shown in FIG. 1B are conductive probes. Conductive probes 110 and 112 are shown inserted into a section of drywall 114, wherein conductive probes 110 and 112 and configured to perform moisture measurements.

In an embodiment, conductive probes 110 and 112 may be configured to measure a voltage difference across the two probes 110 and 112. If moisture has penetrated drywall 114, a change in conductivity between conductive probes 110 and 112 will manifest when measuring a voltage level by way of resistance/impedance at the two conductive probes 110 and 112. The conductivity of the material 114 between the two contacts points 110 and 112 changes the voltage that is measured using analog level. This level is converted to a count value by the use of the Analog to Digital Hardware converter function which may be incorporated in the operating control system (not shown) of moisture monitoring device 100. In an embodiment, the moisture monitoring device 100 may trigger alarms 102 and 104 when the measurement is equivalent to or exceeds 3.0% moisture content. In an embodiment, these moisture content values track the measurement of an exemplary moisture monitoring device between 2.0 and 4.0%. See Table 1.

TABLE 1

| Resistance | Moisture | |
|---|---|---|
| (simulating | monitoring | Moisture monitor |
| wetness in | device reading | with 500K pull |
| the drywall) | (%) | up circuit (Volt) |
| 6.6M | 0.7 | 2.82 |
| 4.4M | 0.8 | 2.72 |
| 2.2M | 0.9 | 2.46 |
| 1.5M | 1.0 | 2.26 |
| 931K | 1.3 | 1.97 |
| 750K | 1.4 | 1.82 |
| 620K | 1.5 | 1.69 |
| 560K | 1.6 | 1.61 |
| 470K | 1.7 | 1.47 |
| 300K | 2.2 | 1.14 |
| 270K | 2.4 | 1.07 |
| 220K | 2.7 | 0.94 |
| 200K | 3.0 | 0.87 |
| 150K | 3.7 | 0.71 |
| 102K | 4.9 | 0.52 |
| 51K | 6.5 | 0.29 |

In an embodiment, when the moisture monitoring device 100 measures less than 0.87 Volts, the alarms 102 and 104 will sound. The conductivity/impedance measurement at which a moisture monitoring device will trigger an alarm response may vary based on a number of parameters, such as ambient air temperature, ambient air humidity, time of day, type of material being probed, elevation of moisture monitoring device, etc. Furthermore, appropriate calibration of the alarm threshold settings of each moisture monitoring device depending at least in part on their unique conditions may improve the accuracy and reliability of a moisture monitoring system.

The embodiment shown in FIG. 1B depicts a monitor with probes extending through the drywall. Though it is not necessary to punch through the wall, it may allow the monitor to register sooner any water which may sheet between the probes on the walls surface.

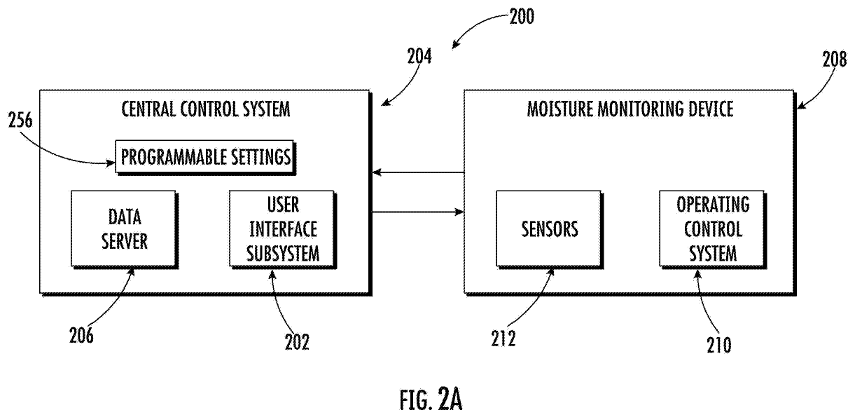

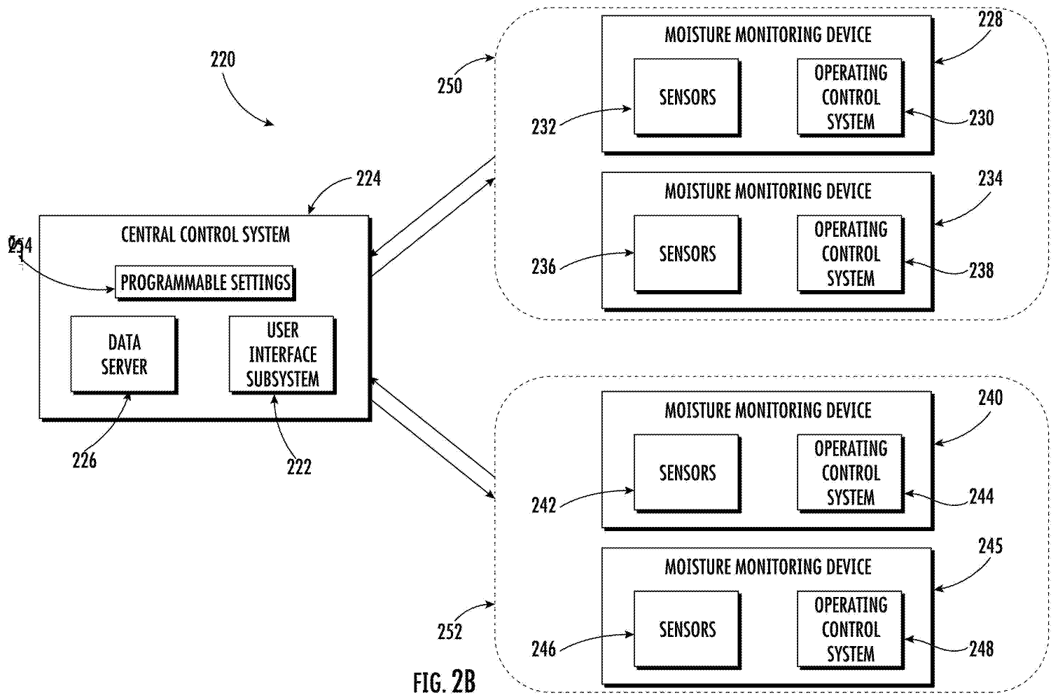

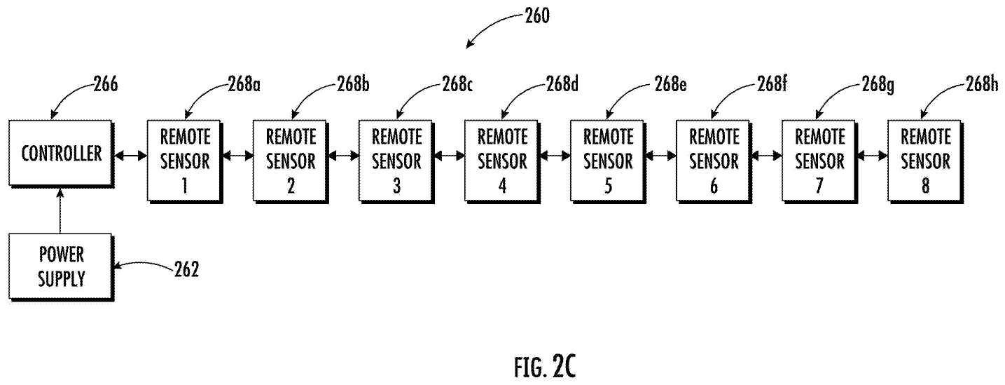

FIG. 2A is a block diagram illustration of an embodiment of a moisture monitoring system 200. Moisture monitoring system 200 comprises moisture monitoring device 208 and central control system 204. Central control system 204 further comprises user interface subsystem 202 and data server 206, and moisture monitoring device 208 further comprises sensors 212 and an operating control system 210 which further comprises operating conditions (not shown). Moisture monitoring device 208 is configured to automatically perform moisture measurements using the operating control system 210 and the sensors 212 in order to collect moisture measurement data from drywall material, which is then sent to and received by the central control system 204. The moisture measurement data is then stored on data server 206, and may be accessed by a user through the user interface subsystem 202.

The central control system 204 is configured to send instructions to the moisture monitoring device 208 to modify the operating conditions of the operating control system 210. If moisture measurement data sent to central control system 204 from moisture monitoring device 208 is above a certain threshold, the central control system 204 may send an instruction to modify the operating conditions of operating control system 210 in order to shorten the interval between automatic moisture measurement data collection events for moisture monitoring device 208. In an embodiment, the central control system 204 may send an instruction to modify the operating conditions of the operating control system 210 to augment a duration of the automatic moisture measurement data collection events.

In an embodiment, the moisture data threshold may be selectable by a user through the user interface subsystem. In addition, the threshold may be dynamic, such that it may be manually or automatically varied over time. For instance, the threshold may vary throughout the course of a day, or from day to day, or may vary depending upon the season or throughout the course of a year, or may automatically vary in response to weather or climate related data. For example, according to the Nation Weather Service's Daily Climate Summary of Lafayette, La. for Jun. 14, 2018, the relative humidity measurement varied from 100% at 1:00 AM to 59% at 11:00 AM, and a threshold may be appropriately configured to account for variations in atmospheric moisture such as this. Furthermore, the threshold may be programmable such that it may vary over time according to user-defined programming. The threshold may also be configured to be overridden by a user wherein the threshold is manually adjusted, the overriding settings being either indefinite or having a defined period of effect.

In moisture monitoring system 200, the central control system 204 may be configured such that when moisture measurement data sent from moisture monitoring device 208 is above a certain threshold, the central control system will send an alert to a user through the user interface subsystem 202. The alert may comprise a text message, a mobile app notification, an email notification, an audible alarm, a visual alarm, or an automated phone call. In addition, the central control system 204 may send an instruction to moisture monitoring device 208 to activate local alarms of the device 208, such as a visual alarm or an audible siren.

FIG. 2B is a block diagram illustration of an embodiment of a moisture monitoring system 220. Moisture monitoring system 220 comprises a central control system 224 which is in communication with first remote subsystem 250 and second remote subsystem 252. The central control system 224 further comprises a user interface subsystem 222 and a data server 226. First remote subsystem 250 further comprises first and second moisture monitoring devices 228, 234, and second remote subsystem 252 further comprises third and fourth moisture monitoring devices 240, 245. Each moisture monitoring device 228, 234, 240, and 245 each further comprise sensors 232, 236, 242, 246, respectively, and an operating control system 230, 238, 244, 248, respectively, comprising operating conditions.

Moisture monitoring device 228 is configured to collect moisture measurement data automatically according to the operating conditions of operating control system 230 by operating sensors 232. The collected moisture measurement data is sent to the central control system 224, where it is stored on data server 226 and is accessible by a user through the user interface subsystem 222. Similarly, moisture monitoring devices 234, 240, and 245 are configured to collect moisture measurement data automatically according to the operating conditions of operating control systems 238, 244, and 248, respectively, by operating sensors 236, 242, and 246, respectively. The collected moisture measurement data is sent to the central control system 224 and stored on data server 226, where it is accessible by a user through the user interface subsystem 222.

The first and second remote subsystems 250 and 252 are located in physically different locations. In embodiments of a moisture monitoring system, the different physical locations of remote subsystems may be different locations on a wall, different walls within a room, different rooms within a building, different floors of a building, different buildings, different street addresses, etc. In an embodiment, the physical location of a particular moisture monitoring device may be associated with the moisture measurement data stored on the data server received from that particular moisture monitoring device.

Central control system 224 is configured to send instructions to either remote subsystem 250 or 252, or to moisture monitoring devices 228, 234, 240, or 245, in order to modify the operating conditions of the respective operating control systems of these remote subsystems or devices. In embodiments of a moisture monitoring system, the instructions may comprise instructions to modify a frequency of an automatic moisture measurement event, a duration of an automatic moisture monitoring event, a moisture measurement data threshold, a moisture monitoring device identification data, a sensor operating parameter, an above-threshold moisture measurement data response behavior, or other moisture monitoring device operating parameters.

In moisture monitoring system 220, the user interface subsystem 222 comprises a user hierarchy, which further comprises a list of users. In an embodiment, each user of the user hierarchy further comprises a number of associated properties, such as user login credentials, user permissions, moisture monitoring device associations, and remote subsystem associations. A user may use the user login credentials to access the central control system through the user interface subsystem, and may modify the central control system based on the associated user permissions. Furthermore, when a remote subsystem or moisture monitoring device sends moisture measurement data to the central control system that triggers an alert response, the user interface subsystem may send the alert only to users associated with the moisture monitoring device or remote subsystem sending the alert-triggering data.

FIG. 2C illustrates an exemplary embodiment of a user interface subsystem where the moisture monitoring device is the primary device, and also function as a hub for several remote conductive probes utilizing first and second sensors that can be extended down the length, depth or height of a wall. In an exemplary embodiment, a user interface subsystem 260 includes a power supply 262 for providing power to a controller 266 coupled to a series of remote sensors 268a-268h. In one embodiment, the controller 266 may be similar to the control systems 204, 224 described above. In another embodiment, the controller 266 may be similar to a moisture monitoring device 208, 228, 234, 240, 245 described above. In one embodiment, the remote sensors 268a-h may be similar to a moisture monitoring device 208, 228, 234, 240, 245 described above. In another embodiment, the remote sensors 268a-h may be similar to the sensors 212, 232, 236, 242, 246 described above.

In operation, the controller 266 can operate like a moisture monitoring device and serve as the primary system in the user interface subsystem. In this instance, the controller 266 is operating like a hub and the remote sensors 268a-267h function similar to remote conductive probes and can be located down the length, depth or height of a wall. These remote sensors 268a-h may be placed anywhere horizontally or vertically along the wall, or into different depths of the wall, to expand the detection range of the user interface subsystem 260.

In one embodiment, there can be a plurality of sensors 268 physically connected in a series. For example, FIG. 2C shows eight sensors 268a-268h physically connected in a series to the main controller 266, e.g., first sensor 268a is connected in to second sensor 268b, second sensor 268b is connected to third sensor 268c, and so forth all the way out to eighth sensor 268h.

It will be appreciated that although eight sensors 268 are shown and all along the same x-axis, there can be fewer or more sensors 268 as necessary depending on the size of the wall and that the sensors 268 may be located along the x-, y- or z-axes, or at 45 degrees, or a variety of configuration. In other words, the remote sensors 268 can function as extensions from the primary moisture monitoring device 266 to provide more coverage for the wall and with just using one unit of the moisture monitoring device 266.

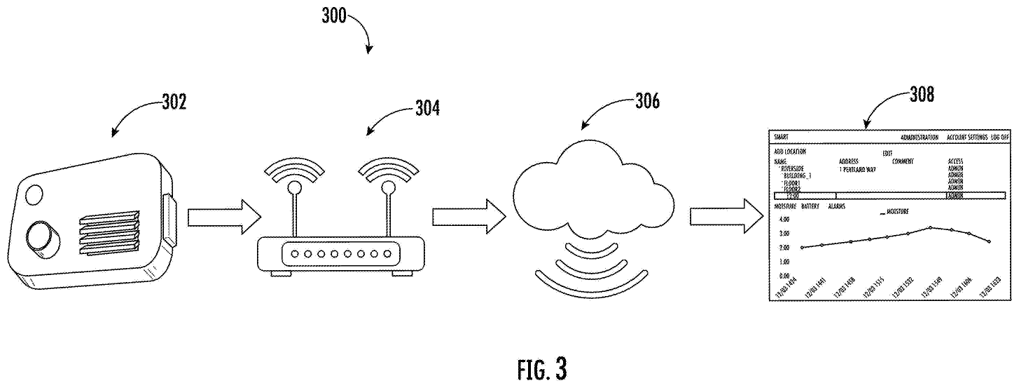

FIG. 3 is a flow chart illustration of an embodiment of a moisture monitoring system 300. FIG. 3 illustrates a conceptual visualization of how data, such as moisture measurement data, may move through the infrastructure of a moisture monitoring system. First, moisture measurement data is collected by a moisture monitoring device 302. Device 302 then interfaces with a local internet access hub, such as communication device 304, which may be integral or separate from device 302. In other embodiments, device 302 may communicate through a number of interfacial communication schema, such as Bluetooth, radio frequency, infrared, microwave, physical data connection, or other communication protocols. Device 302 may further comprise additional physical electronic components in order to accommodate a desired communication medium, and programming for such may be comprised in the operating control system of device 302.

Moisture measurement data received by Wi-Fi router 304 is then routed to corresponding central control system 306. Central control system 306 may be set up on a local, isolated network, or may be a remote or cloud-based or decentralized server. Central control system 306 is configured to analyze received moisture measurement data, and to store said data in a data server (not shown) which may also be cloud-based or may be integrated directly into central control system 306. Furthermore, central control system 306 may further comprise a user interface subsystem 308. Upon request, central control system may present a user with moisture measurement data readouts, or other settings, through the user interface subsystem 308. Additionally, if automatically collected moisture measurement data sent to central control system 306 is above a certain threshold, the central control system 306 will alert a user through the user interface subsystem 308, identifying which moisture monitoring device 302 the above-threshold data was sent from, so that the user can investigate the device to search for possible water leaks, for example.

In certain embodiments, Wi-Fi router 304, or a similar type of communication infrastructure, may be integrated directly into moisture monitoring device 302, thus allowing moisture monitoring device 302 to communicate directly with central control system 306.

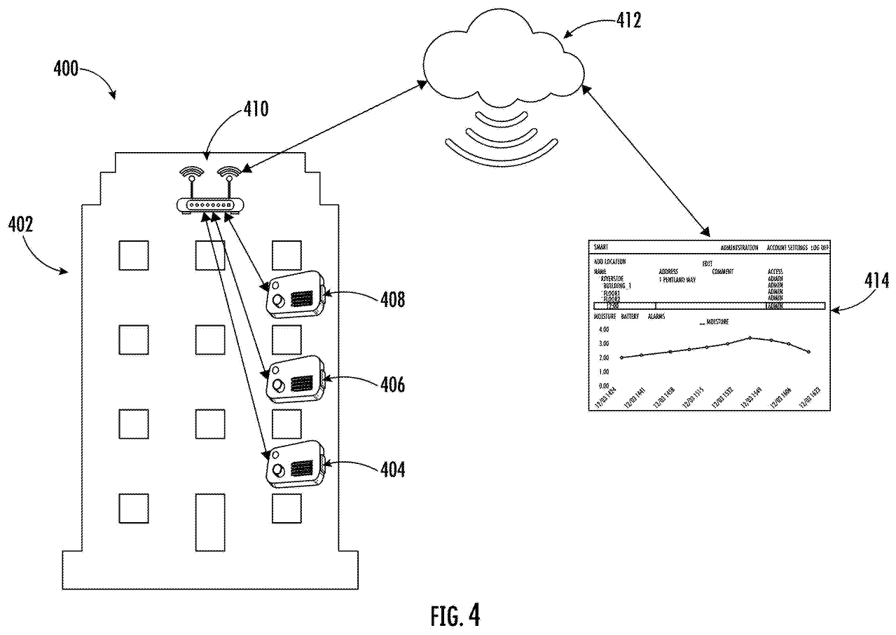

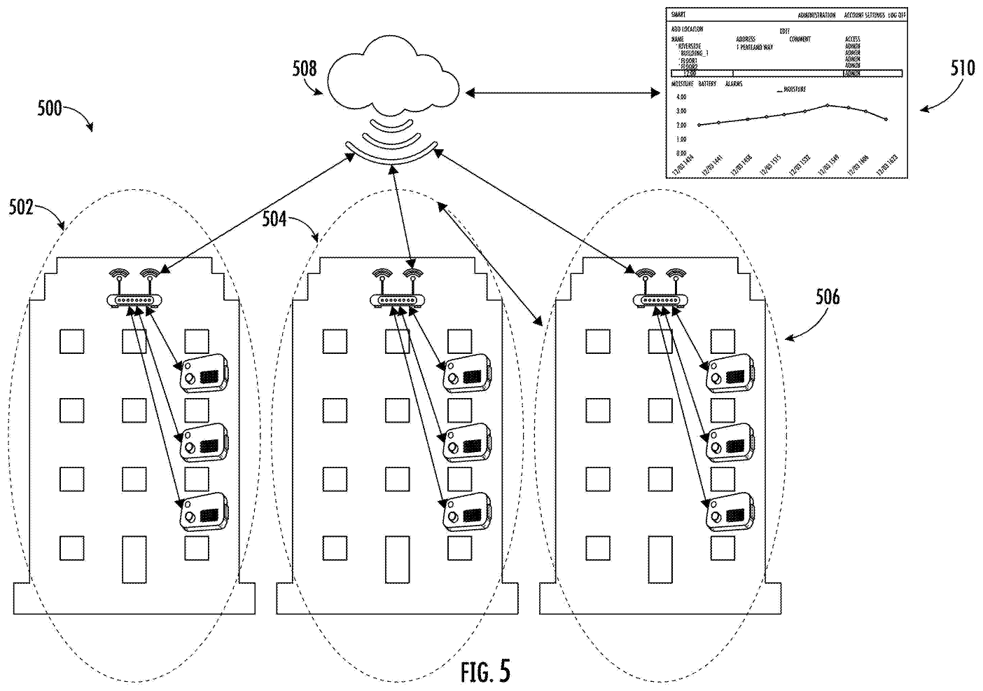

FIG. 4 illustrates an embodiment of a moisture monitoring system 400 comprising a first remote subsystem 402. In the embodiment shown, remote subsystem 402 corresponds to the illustrated building. Remote subsystem 402 further comprises moisture monitoring devices 404, 406, and 408, as well as networking device 410. Each moisture monitoring device 404, 406, and 408 are located in a different physical location, which in moisture monitoring system 400 happens to be different floors of the illustrated building corresponding to remote subsystem 402. Each device 404, 406, and 408 is in communication with networking device 410, which in turn is in communication with and serves as a signal router between central control system 412 and devices 404, 406, and 408. Central control system 412 also further comprises a user interface subsystem 414, which allows a user to access central control system 412.

In FIG. 4, devices 404, 406, and 408 perform automatic moisture measurements to collect moisture measurement data, which is then routed through networking device 410 to central control system 412. Central control system 412 receives this moisture measurement data and stores it, along with meta-data or other identifying information associated with the moisture measurement devices 404, 406, and 408, such as which remote subsystem these devices belong to, or which floor they are located on. If central control system 412 receives moisture measurement data above a certain threshold, it will send an alert through the user interface subsystem 414 to a user. This alert may comprise auditory or visual alarms or text notifications, which may comprise the associated remote subsystem and other identifying information associated with the above-threshold moisture measurement data being received.

FIG. 5 illustrates an embodiment of a moisture monitoring system 500 comprising first, second, and third remote subsystems 502, 504, and 506, respectively. Moisture monitoring system 500 operates similarly to moisture monitoring system 400 from FIG. 4, except that central control system 500 is now in communication with multiple remote subsystems, each with a networking device and a plurality of moisture monitoring devices. As illustrated in FIG. 5, each remote subsystem is located in a different physical location. Moisture monitoring system 500 serves to illustrate that the number of remote subsystems belonging to embodiments of a moisture monitoring system is highly scalable depending on a user's preference and to accommodate any number of different physical locations.

In an embodiment, a moisture monitoring device may be battery powered, such as by a 9-Volt battery, or may be powered by a dedicated power source such as a wall electrical outlet.

Furthermore, in an embodiment of a moisture monitoring system, in the event that a moisture monitoring device, or an entire remote subsystem, becomes inoperable, perhaps due to power failure or unauthorized tampering, a central control system will still be functional and operable to continue communication with the remaining remote subsystems and moisture monitoring devices, and may send an alert to the appropriate user or users notifying them of the outage. Additionally, in the event of a loss of communication between moisture monitoring devices or remote subsystems and the central control system, such as in the event the central control system is rendered inoperable, the moisture monitoring devices may be configured to continue moisture monitoring operations, storing collected moisture measurement data locally until communication is restored with the central control system, and operable to deploy an alert if above-threshold moisture measurement data is detected. In an embodiment, an alternate set of emergency operating conditions may be stored in the operating control system of each moisture monitoring device and may be activated in the event communication with the central control system is lost.

In an embodiment, moisture monitoring devices may be placed under sinks, under toilets, in close proximity to a shower or bathtub, near appliances such as dishwashers or laundry machines, or wherever water pipes are present, which may provide for quicker or more effective detection of undesired moisture within a structure. Furthermore, due to the wicking of unwanted moisture within a drywall cavity, a moisture monitoring device may not need to be placed directly adjacent to potential sources of water leaks, but may be placed instead in a general proximity.

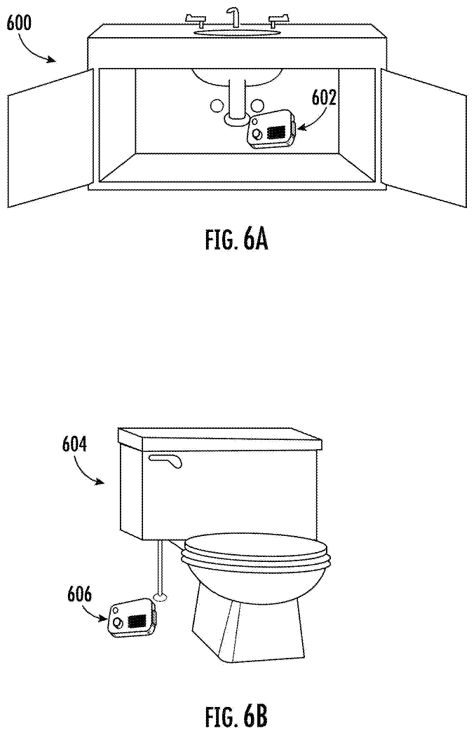

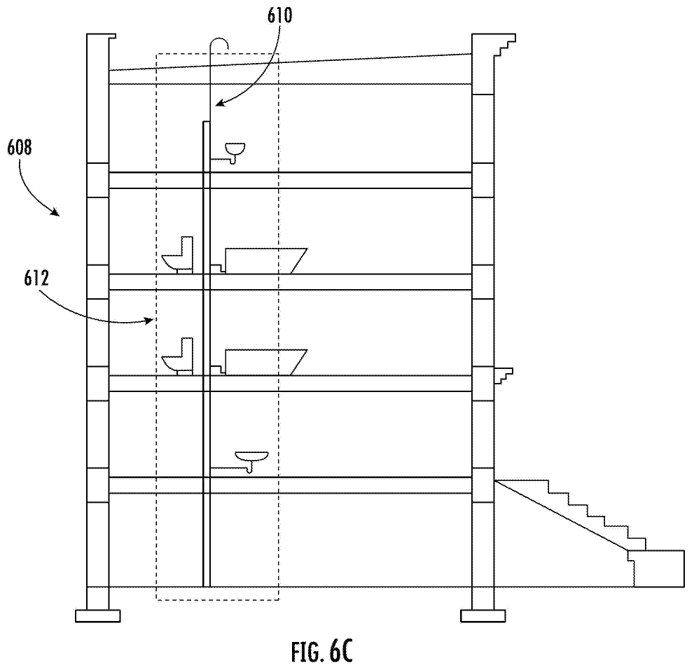

FIG. 6A-FIG. 6C illustrate exemplary embodiments of locations where a moisture monitoring device may be located. In FIG. 6A, an embodiment is shown of a location 600 featuring moisture monitoring device 602. Location 600 comprises a sink, with water plumbing shown underneath a countertop, which is prone to developing leaks over time. Locating moisture monitoring device 602 underneath the illustrated plumbing may ensure that any leaks in said plumbing are quickly detected by moisture monitoring device 602 so that they may be expeditiously addressed.

FIG. 6B illustrates an embodiment of a location 604. In location 604, a toilet is shown with water plumbing extending behind the toilet. This presents another possible location were water leaks may occur, and placing a moisture monitoring device 606 as illustrated beneath said plumbing may ensure any leaks are detected by moisture monitoring device 606.

FIG. 6C illustrates an embodiment of a location 608. In location 608, a typical piping configuration for a multi-story building is shown. The water pipes of the building are illustrated at 610, and the region labeled 612 represents the area immediately surrounding water pipes 610. In the event a leak develops anywhere along water pipes 610, region 612 represents an ideal area for locating moisture monitoring devices to ensure that said leaks are promptly detected by a moisture monitoring system.

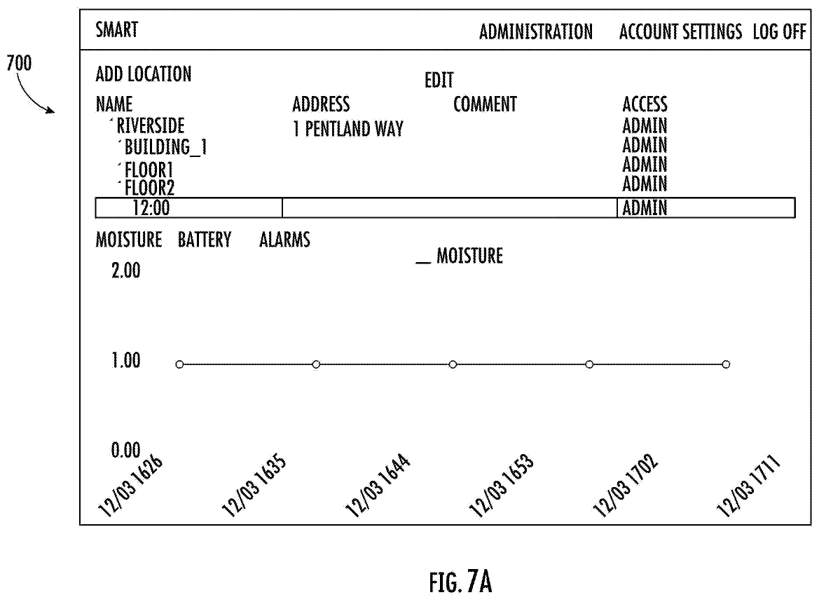

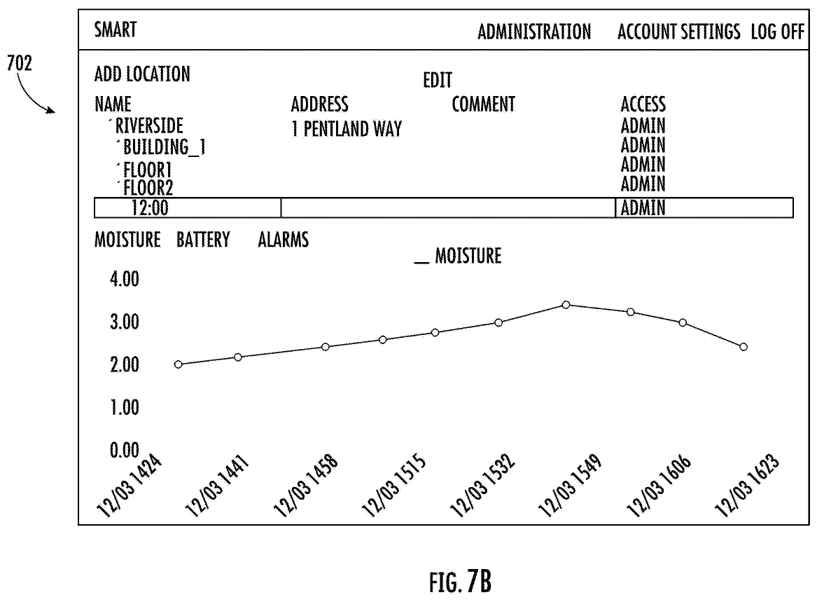

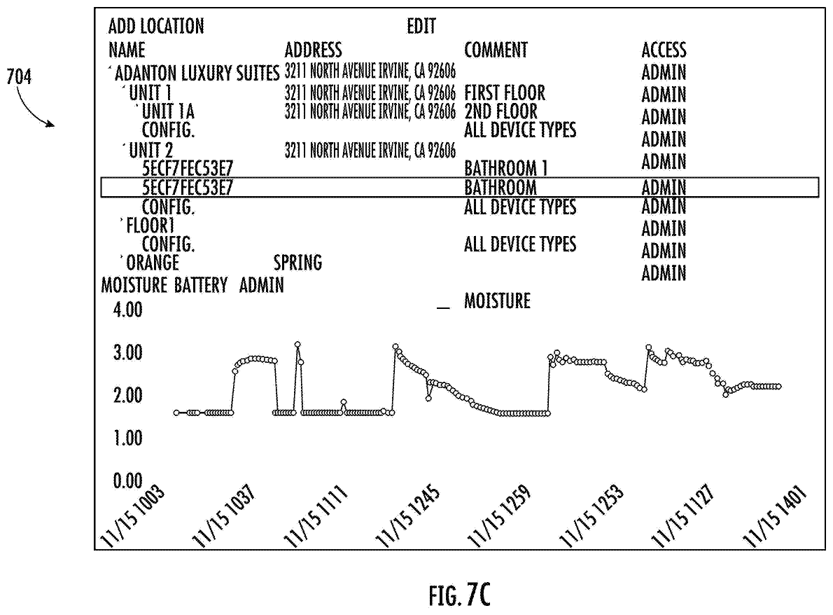

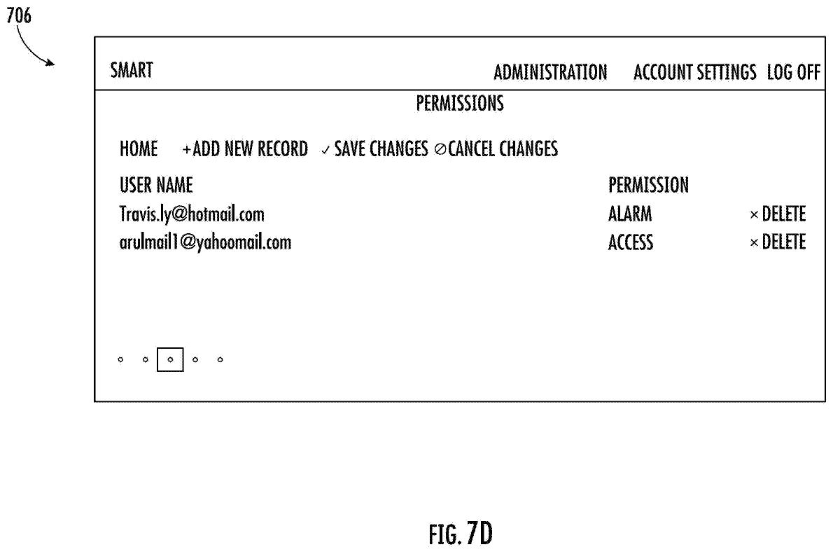

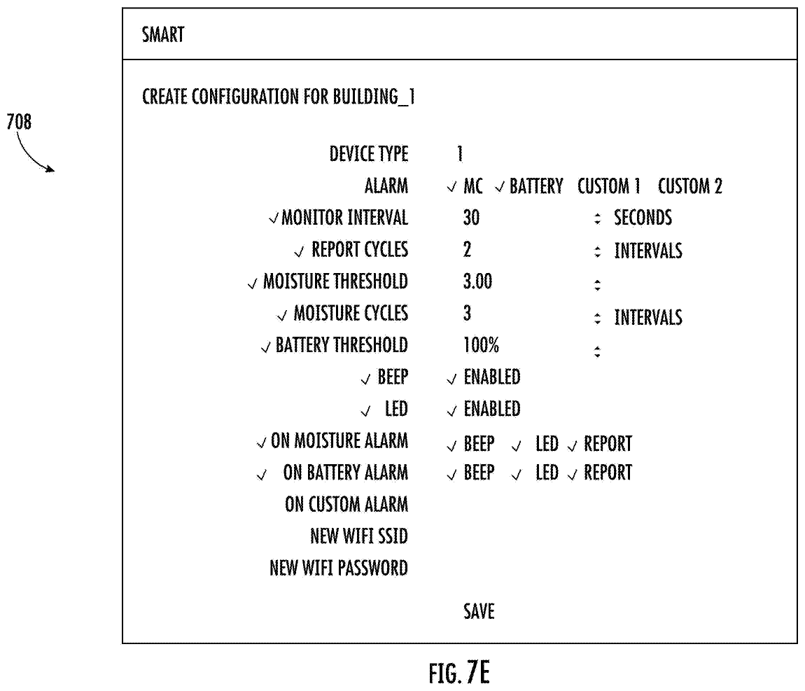

FIG. 7A-FIG. 7E illustrate embodiments of a user interface subsystem of a moisture monitoring system.

FIG. 7A illustrates an embodiment 700 of a user interface subsystem. In embodiment 700, the moisture measurement data for a particular moisture monitoring device is displayed as a graphical chart showing each moisture measurement event and its corresponding collected data. In addition, identifying information, such as address and floor location of the particular moisture monitoring device are displayed. In an embodiment, a user may, as desired, view the historically collected data of a moisture monitoring device, which may help determine if a moisture monitoring system is performing appropriately.

FIG. 7B illustrates an embodiment 702 of a user interface subsystem. In embodiment 702, moisture measurement data for a particular moisture measurement deice is displayed. In embodiment 702, moisture measurement data is shown to be increasing over time, followed by a subsequent decline in moisture levels. This pattern may indicate a temporary moisture level increase, such as a transient spillage or other minor event, and may not warrant an alert be generated by a central control system. However, if a pattern of elevated moisture measurement data continues, the central control system may generate an alert.

FIG. 7C illustrates an embodiment 704 of a user interface subsystem. In embodiment 704, a moisture monitoring device is intentionally exposed to different levels of moisture in order to calibrate an appropriate threshold and response behavior. While calibration of a moisture monitoring device is not required, in embodiments it may improve the accuracy of the moisture measurement data collected by moisture monitoring devices.

FIG. 7D illustrates an embodiment 706 of a user interface subsystem. In embodiment 706, a user hierarchy is shown, featuring a list of users. In embodiments of a moisture monitoring system, a central control system may comprise a user hierarchy with a list of users and settings associated with these users, the settings comprising name, contact information, associated remote subsystems or moisture monitoring devices, or permissions, among other things. The central control system may be configured to send an alert to users from the user hierarchy based on which remote subsystem an above-first threshold moisture measurement data is sent from, and further based on the individual settings associated with each unique user.

FIG. 7E illustrates an embodiment 708 of a user interface subsystem. In an embodiment of a moisture monitoring system, the central control system may be a web-based application comprising a data server and programmable settings. Embodiment 708 shows a user interface for accessing and modifying the programmable settings of the central control system. The programmable settings may comprise instructions to be sent to a remote subsystem of moisture monitoring devices, or ‘rules’ for handling data received from remote subsystems. A user with appropriate permissions may access the programmable settings of the central control system through the user interface subsystem, such as shown in embodiment 708. For example, through accessing the user interface subsystem, a user with appropriate permissions may modifying the alert level moisture threshold of a remote subsystem comprising several moisture monitoring devices. The central control system will then forward the new moisture threshold to every device within the remote subsystem, thereby modifying the operating conditions of their operating control systems.

By accessing the central control system through the user interface subsystem, a user may be able to view and adjust the settings of the remote subsystems, and of the individual moisture monitoring devices, which are in communication with the central control system. After modifying settings through the user interface subsystem, the central control system may then forward the modified settings to the appropriate devices, thereby modifying their operating conditions. The embodiments of a moisture monitoring system described herein thereby allow a user to view data and modify settings of a large network of devices from a single, convenient interface which is accessible anywhere through the internet. In addition, signals from said large network of devices, such as moisture alarms, low battery alerts, or other types of alerts, may be collectively received by a central control system and forwarded to a user through the user interface subsystem, eliminating the need to manually service and check each device in person, which are often located in inconvenient or remote locations.

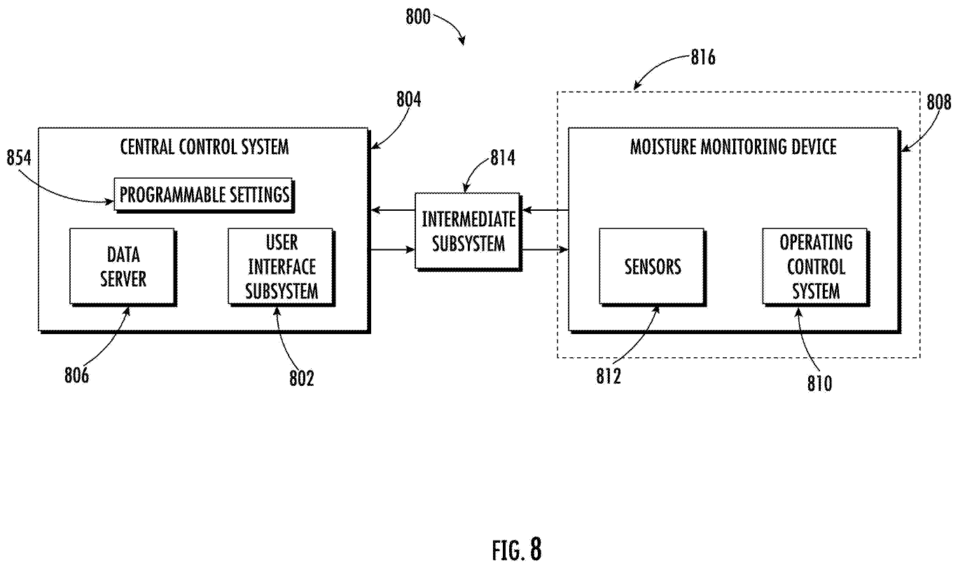

FIG. 8 is a block diagram illustration of an embodiment of a moisture monitoring system 800 comprising an intermediate subsystem 814. The moisture monitoring system 800 may function similarly to the moisture monitoring system 200 shown in FIG. 2A, with the exception that moisture monitoring system 800 further comprises an intermediate subsystem 814. The intermediate subsystem 814 may be operable to communicate with the central control system 804 and with remote subsystem 816 which comprises first moisture monitoring device 808. In the embodiment shown in FIG. 8, the intermediate subsystem 814 acts as a communication bridge between central control system 804 and remote subsystem 816. In certain embodiments not shown, an intermediate subsystem may be in communication with multiple remote subsystems, simultaneously linking them with a central control system, or may be in communication with multiple central control systems, simultaneously linking them with a remote subsystem or moisture monitoring device. Embodiments of an intermediate subsystem may comprise a Wi-Fi router or internet modem network, or a digital personal assistant such as a voice operated digital personal assistant device.

In an embodiment, the intermediate subsystem may function as a central communications hub. The intermediate subsystem may operate as a hub for multiple moisture monitoring devices, or for multiple remote subsystem.

In various embodiments, a user may interface with the user interface subsystem through operation of an intermediate subsystem, which may allow them access to a central control system or to a network of remote subsystems.

An embodiment may comprise a method for monitoring moisture, as well as a method for installing a moisture monitoring system consistent with the present disclosure. A method may comprise providing a central control system and a plurality of moisture monitoring devices. Furthermore, a method may comprise installing a plurality of moisture monitoring devices, and configuring a central control system to communicate with the plurality of moisture monitoring devices consistent with the present disclosures.

Foregoing described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks. Other variations and embodiments are possible in light of above teachings, and it is thus intended that the scope of invention not be limited by this Detailed Description, but rather by Claims following. Furthermore, the above advantages and features are provided in described embodiments, but shall not limit the application of such issued claims to processes and structures accomplishing any or all of the above advantages.

It will be understood that the principal features of this disclosure can be employed in various embodiments without departing from the scope of the disclosure. Those skilled in the art will recognize, or be able to ascertain using no more than routine experimentation, numerous equivalents to the specific procedures described herein. Such equivalents are considered to be within the scope of this disclosure and are covered by the claims.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically, and by way of example, although the headings refer to a “Field of Invention,” such claims should not be limited by the language under this heading to describe the so-called technical field. Further, a description of technology in the “Background of the Invention” section is not to be construed as an admission that technology is prior art to any invention(s) in this disclosure. Neither is the “Summary” to be considered a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

What is claimed is:

1. A moisture monitoring system, the system comprising:
a central control system comprising a user interface subsystem and programmable settings;
a plurality of moisture monitoring devices, each moisture monitoring device comprising:
first and second sensors, and
an operating control system comprising operating conditions;
wherein the plurality of moisture monitoring devices are configured to automatically perform a plurality of moisture measurements to collect moisture measurement data from drywall material using the first and second sensors;
wherein a first remote subsystem comprises a first portion of the plurality of moisture monitoring devices, and a second remote subsystem comprises a second portion of the plurality of moisture monitoring devices, the first and second remote subsystems being in communication with the central control system and located in different physical locations;
wherein the central control system is configured to receive and store moisture measurement data from the first and second remote subsystems, and to send instructions to the first and second remote subsystems to modify the operating conditions of the operating control systems of the first and second portions of the plurality of moisture monitoring devices;
wherein the central control system is configured such that at least the programmable settings are accessible by a user through the user interface subsystem; and
wherein, when the central control system receives moisture measurement data that is above an alert threshold, the central control system sends an alert to a user through the user interface subsystem.

2. The moisture monitoring system of claim 1, wherein the different physical locations comprise one of: different walls within a room, different walls within a structure, different rooms within a structure, different floors of a structure, different structures, or different street addresses.

3. The moisture monitoring system of claim 1, wherein the operating conditions comprise a frequency of measurement.

4. The moisture monitoring system of claim 1, wherein the operating conditions comprise a duration of measurement.

5. The moisture monitoring system of claim 1, wherein the central control system is a web-based application comprising a data server which is accessible by a user through the user interface subsystem.

6. The moisture monitoring system of claim 5, wherein the programmable settings are configured to be modifiable by a user through the user interface subsystem.

7. The moisture monitoring system of claim 1, wherein the central control system comprises a user hierarchy and is configured to send the alert to users from the user hierarchy based on which remote subsystem the above-first threshold moisture measurement data was sent from.

8. The moisture monitoring system of claim 1, wherein the user interface subsystem comprises a web interface accessed through an internet browser or a mobile app.

9. The moisture monitoring system of claim 1, wherein the alert comprises a notification selected from a group consisting of:
a. a text message,
b. a mobile app notification,
c. an email notification,
d. an audible alarm,
e. a visual alarm, and
f. an automated phone call;

10. The moisture monitoring system of claim 1, wherein a first moisture monitoring device of the plurality of moisture monitoring devices is configured such that when the first moisture monitoring device collects moisture measurement data above the alert threshold, the first moisture monitoring device emits either of an audible alarm, a visual alarm, or both.

11. The moisture monitoring system of claim 1, wherein, when moisture measurement data sent to the central control system from a first moisture monitoring device of the plurality moisture monitoring devices is above a screening threshold, the central control system instructs the operating control system of the first moisture monitoring device to increase a frequency of measurement of the operating conditions of the first moisture monitoring device.

12. The moisture monitoring system of claim 11, wherein, if the moisture measurement data of the first moisture monitoring device continues to be above the screening threshold after a set number of measurement cycles after the frequency of measurement of the first moisture monitoring device has been increased, then the central control system sends the alert through the user interface subsystem.

13. The moisture monitoring system of claim 1, wherein the first and second sensors of the plurality of moisture monitoring devices comprise conductive probes, and moisture measurement data comprises a voltage difference measured across the first and second sensors of a first moisture monitoring device of the plurality of moisture monitoring devices.

14. The moisture monitoring system of claim 1, wherein the alert threshold is dynamic.

15. The moisture monitoring system of claim 1, further comprising an intermediate subsystem wherein the intermediate subsystem is operable to communicate with the central control system and with at least the first or second remote subsystems.

16. A method of moisture monitoring, the method comprising:
providing a central control system comprising a user interface subsystem and programmable settings; and
receiving moisture measurement data at the central control system from a plurality of moisture monitoring devices, each moisture monitoring device comprising:
first and second sensors, and
an operating control system comprising operating conditions;
wherein the plurality of moisture monitoring devices are configured to automatically perform a plurality of moisture measurements to collect the moisture measurement data from drywall material using the first and second sensors;
wherein a first remote subsystem comprises a first portion of the plurality of moisture monitoring devices, and a second remote subsystem comprises a second portion of the plurality of moisture monitoring devices, the central control system communicating with the first and second remote subsystems, the first and second remote subsystems being located in different physical locations;
wherein the central control system stores moisture measurement data from the first and second remote subsystems, and sends instructions to the first and second remote subsystems to modify the operating conditions of the operating control systems of the first and second portions of the plurality of moisture monitoring devices;
wherein the central control system is configured such that at least the programmable settings are accessible by a user through the user interface subsystem; and
wherein, when the central control system receives moisture measurement data that is above an alert threshold, the central control system sends an alert to a user through the user interface subsystem.

17. The method of moisture monitoring of claim 16, wherein the different physical locations comprise one of: different walls within a room, different walls within a structure, different rooms within a structure, different floors of a structure, different structures, or different street addresses.

18. The method of moisture monitoring of claim 16, wherein the operating conditions comprise a frequency of measurement.

19. The method of moisture monitoring of claim 16, wherein the operating conditions comprise a duration of measurement.

20. The method of moisture monitoring of claim 16, wherein the central control system is a web-based application comprising a data server which is accessible by a user through the user interface subsystem.

21. The moisture monitoring system of claim 20, wherein the programmable settings are configured to be modifiable by a user through the user interface subsystem.

22. The method of moisture monitoring of claim 16, wherein the central control system comprises a user hierarchy and is configured to send the alert to users from the user hierarchy based on which remote subsystem the above-first threshold moisture measurement data was sent from.

23. The method of moisture monitoring of claim 16, wherein the user interface subsystem comprises a web interface accessed through an internet browser or a mobile app.

24. The method of moisture monitoring of claim 16, wherein the alert comprises a notification selected from a group consisting of:
a. a text message,
b. a mobile app notification,
c. an email notification,
d. an audible alarm,
e. a visual alarm, and
f. an automated phone call;

25. The method of moisture monitoring of claim 16, wherein a first moisture monitoring device of the plurality of moisture monitoring devices is configured such that when the first moisture monitoring device collects moisture measurement data above the alert threshold, the first moisture monitoring device emits either of an audible alarm, a visual alarm, or both.

26. The method of moisture monitoring of claim 16, wherein, when moisture measurement data sent to the central control system from a first moisture monitoring device of the plurality moisture monitoring devices is above a screening threshold, the central control system instructs the operating control system of the first moisture monitoring device to increase a frequency of measurement of the operating conditions of the first moisture monitoring device.

27. The method of moisture monitoring of claim 16, wherein, if the moisture measurement data of the first moisture monitoring device continues to be above the screening threshold after a set number of measurement cycles after the frequency of measurement of the first moisture monitoring device has been increased, then the central control system sends the alert through the user interface subsystem.

28. The method of moisture monitoring of claim 16, wherein the first and second sensors of the plurality of moisture monitoring devices comprise conductive probes, and moisture measurement data comprises a voltage difference measured across the first and second sensors of a first moisture monitoring device of the plurality of moisture monitoring devices.

29. The method of moisture monitoring of claim 16, wherein the alert threshold is dynamic.

30. The method of moisture monitoring of claim 16, further comprising providing an intermediate subsystem wherein the intermediate subsystem is operable to communicate with the central control system and with at least the first or second remote subsystems.

31. A method of installing a moisture monitoring system, the method comprising:
providing a central control system comprising a user interface subsystem and programmable settings; and
providing a plurality of moisture monitoring devices, each moisture monitoring device comprising:
first and second sensors, and
an operating control system comprising operating conditions;
installing each of the plurality of moisture monitoring devices in drywall material located at different physical locations;
connecting the plurality of moisture monitoring devices to the central control system;
configuring the plurality of moisture monitoring devices to automatically perform a plurality of moisture measurements to collect moisture measurement data from the drywall material using the first and second sensors;
configuring the central control system to receive and store moisture measurement data from the first and second remote subsystems, and to send instructions to the first and second remote subsystems to modify the operating conditions of the operating control systems of the first and second portions of the plurality of moisture monitoring devices;
wherein the central control system is configured such that at least the programmable settings are accessible by a user through the user interface subsystem; and
wherein, when the central control system receives moisture measurement data that is above an alert threshold, the central control system send an alert to a user through the user interface subsystem.

32. The method of installing a moisture monitoring system of claim 31, further comprising:
providing an intermediate subsystem; and
connecting the intermediate subsystem with the central control system and with at least one moisture monitoring device such that the intermediate subsystem is operable to communicate with the central control system and the at least one moisture monitoring device.

33. The method of installing a moisture monitoring system of claim 31, further comprising:
defining a first remote subsystem comprises a first portion of the plurality of moisture monitoring devices, and a second remote subsystem comprises a second portion of the plurality of moisture monitoring devices; and
configuring the first and second remote subsystems to communicate with the central control system.

34. The method of installing a moisture monitoring system of claim 31, wherein the different physical locations comprise one of: different walls within a room, different walls within a structure, different rooms within a structure, different floors of a structure, different structures, or different street addresses.

35. The method of installing a moisture monitoring system of claim 31, wherein the operating conditions comprise a frequency of measurement.

36. The method of installing a moisture monitoring system of claim 31, wherein the operating conditions comprise a duration of measurement.

37. The method of installing a moisture monitoring system of claim 31, wherein the central control system is a web-based application comprising a data server which is accessible by a user through the user interface subsystem.

38. The method of installing a moisture monitoring system of claim 31, further comprising configuring the programmable settings to be modifiable by a user through the user interface subsystem.

39. The method of installing a moisture monitoring system of claim 31, wherein the central control system comprises a user hierarchy; and
configuring the central control system to send the alert to users from the user hierarchy based on which remote subsystem the above-first threshold moisture measurement data was sent from.

40. The method of installing a moisture monitoring system of claim 31, wherein the user interface subsystem comprises a web interface accessed through an internet browser or a mobile app.

41. The method of installing a moisture monitoring system of claim 31, wherein the alert comprises a notification selected from a group consisting of:
a. a text message,
b. a mobile app notification,
c. an email notification,
d. an audible alarm,
e. a visual alarm, and
f. an automated phone call;

42. The method of installing a moisture monitoring system of claim 31, further comprising configuring a first moisture monitoring device of the plurality of moisture monitoring devices such that when the first moisture monitoring device collects moisture measurement data above the alert threshold, the first moisture monitoring device emits either of an audible alarm, a visual alarm, or both.

43. The method of installing a moisture monitoring system of claim 31, further comprising configuring the central control system such that when moisture measurement data sent to the central control system from a first moisture monitoring device of the plurality moisture monitoring devices is above a screening threshold, the central control system instructs the operating control system of the first moisture monitoring device to increase a frequency of measurement of the operating conditions of the first moisture monitoring device.

44. The method of installing a moisture monitoring system of claim 31, further comprising configuring the central control system such that, if the moisture measurement data of the first moisture monitoring device continues to be above the screening threshold after a set number of measurement cycles after the frequency of measurement of the first moisture monitoring device has been increased, then the central control system sends the alert through the user interface subsystem.

45. The method of installing a moisture monitoring system of claim 31, wherein the first and second sensors of the plurality of moisture monitoring devices comprise conductive probes, and moisture measurement data comprises a voltage difference measured across the first and second sensors of a first moisture monitoring device of the plurality of moisture monitoring devices.

46. The method of installing a moisture monitoring system of claim 31, wherein the alert threshold is dynamic.

47. The method of installing a moisture monitoring system of claim 31, further comprising providing an intermediate subsystem; and
configuring the intermediate subsystem to communicate with the central control system and with at least the first or second remote subsystems.
